(19) United States
(12) Patent Application Publication
(10) Pub. No.: US 2005/0208332 A1
(43) Pub. Date: Sep. 22, 2005

(54) White-light-emitting organic electroluminescent device and organic electroluminescent display having the same

(76) Inventors: Byung-Doo Chin, Seongnam-si (KR); Mu-Hyun Kim, Suwon-si (KR); Seong-Taek Lee, Suwon-si (KR); Nam-Choul Yang, Seoul (KR); Min-Chul Suh, Seongnam-si (KR); Lian Duan, Suwon-si (KR)

Correspondence Address: MCGUIREWOODS, LLP, 1750 TYSONS BLVD, SUITE 1800, MCLEAN, VA, 22102, US

(21) Appl. No.: 11/081,764

(22) Filed: Mar. 17, 2005

(30) Foreign Application Priority Data
Mar. 17, 2004 (KR) 2004-18121

(51) Int. Cl. H05B 33/14

(52) U.S. Cl. 428/690; 428/917; 313/504; 313/506; 313/112; 257/98

(57) ABSTRACT

A white-light-emitting organic electroluminescent device and organic electroluminescent display having the same may include a first electrode, a second electrode, and an emission layer interposed between the first electrode and the second electrode. The emission layer may have a structure in which a polymer emission layer and a small-molecule emission layer are stacked.

### CROSS-REFERENCE TO RELATED APPLICATION

This application claims priority to and the benefit of Korean Patent Application No. 2004-18121, filed Mar. 17, 2004, which is incorporated herein by reference in its entirety.

### BACKGROUND OF THE INVENTION

1. Field of the Invention

The present invention relates to an organic electroluminescent (EL) device and an organic EL display having the same and, more particularly, to a white-light-emitting organic EL device and organic EL display having the same.

2. Description of the Related Art

Organic EL devices emitting white light have been used as paper-thin light sources, backlights for liquid crystal displays (LCDs), full color displays employing a color filter, and the like.

Korean Patent Application No. 2001-0033140 discloses such a white-light-emitting organic EL device. There, a polymer material is used in which 3,3′-bicarbazyl is introduced into a polyarylene polymer main chain to form an emission layer. Thus, an emission spectrum having a large width, namely, good white light may be implemented. The luminous efficiency may be about 0.06 cd/A to about 0.35 cd/A.

However, the white-light-emitting organic EL device may be a small-molecule-based multilayer device having at least two emission layers formed of small molecules so that it may have good luminous efficiency, however, it is not easy to find an optimized condition for each constitutional layer in order to implement the white light.

### SUMMARY OF THE INVENTION

The present invention, therefore, may solve the aforementioned problems associated with conventional devices by providing a white-light-emitting organic EL device with improved luminous efficiency that is easy to implement, and an organic EL display having the same.

In an exemplary embodiment of the present invention, a white-light-emitting organic electroluminescent (EL) device may include a first electrode, a second electrode, and an emission layer interposed between the first electrode and the second electrode. The emission layer may have a structure in which a polymer emission layer and a small-molecule emission layer are stacked.

In another exemplary embodiment of the present invention, an organic electroluminescent (EL) display may include a first electrode and a second electrode. At least one of the electrodes may be a transparent electrode. It may also include an emission layer interposed between the first electrode and the second electrode. The emission layer may have a structure in which a polymer emission layer and a small-molecule emission layer are stacked. The emission layer may be adapted to emit white light when driven. The display may also include a color filter layer positioned in the emission path of light from the emission layer.

In the organic EL device and the organic EL display, the polymer emission layer may emit light in the blue range, and the small-molecule emission layer may emit light in an orange-red range.

The polymer emission layer emitting the light in the blue range may be formed of one polymer or a copolymer of at least two kinds. Suitable materials may include, for example, materials such as poly phenylenevinylene (PPV)-based, polyfluorene-based, poly p-phenylene (PPP)-based, polyalkylthiophene-based, or polypyridine (Ppy)-based polymers.

The small-molecule emission layer emitting light in the orange-red range may preferably emit phosphorescent light in the orange-red range. The small-molecule emission layer emitting the phosphorescent light in the orange-red range may include a host material such as CBP(4,4-N,N dicarbazole-biphenyl), a CBP derivative, mCP(N,N-dicarbazolyl-3,5-benzene), or an mCP derivative. In addition, the small-molecule emission layer emitting the phosphorescent light in the orange-red range may include a dopant material such as PQIr, PQIr(acac), PQ₂Ir(acac), PIQIr(acac), or PtOEP.

Alternatively, in the organic EL device and the organic EL display, the polymer emission layer may emit light in the orange-red range, and the small-molecule emission layer may emit light in the blue range.

The polymer emission layer emitting light in the orange-red range may be formed of a copolymer of one polymer such as poly phenylenevinylene (PPV)-based, polyfluorene-based, poly p-phenylene (PPP)-based, polyalkylthiophene-based, or polypyridine (PPy)-based polymers, and a polymer such as a PPV-based or polyalkylthiophene-based polymer.

The small-molecule emission layer emitting light in the blue range may preferably emit fluorescent light in the blue range. The small-molecule emission layer emitting fluorescent light in the blue range may include a material such as distyrylarylene (DSA), a DSA derivative, distyrylbenzene (DSB), a DSB derivative DPVBi(4,4′-bis(2,2′-diphenyl vinyl)-1,1′-biphenyl), a DPVBi derivative, spiro-DPVBi, or spiro-6P(spiro-sexyphenyl). Furthermore, the small-molecule emission layer emitting fluorescent light in the blue range may further include a dopant material such as styrylamine-based, pherylene-based, or DSBP(distyrylbiphenyl)-based materials.

### BRIEF DESCRIPTION OF THE DRAWINGS

FIG. 1 is a cross-sectional view illustrating an organic EL device and method of fabricating the same in accordance with a first embodiment of the present invention.

FIG. 2 is a cross-sectional view illustrating an organic EL display and method of fabricating the same in accordance with a second embodiment of the present invention.

### DETAILED DESCRIPTION OF THE INVENTION

Details of the present invention, its technical configuration, and its operating effect are illustrated by the detailed description below with reference to accompanying drawings, in which exemplary embodiments of the invention are shown.

In the drawings, when a layer is described to be formed on other layers or on a substrate, the layer may be formed directly on the other layers or on the substrate, or a third (or additional) layer may be interposed between the layer and the other layers or the substrate. Like numbers refer to like elements throughout.

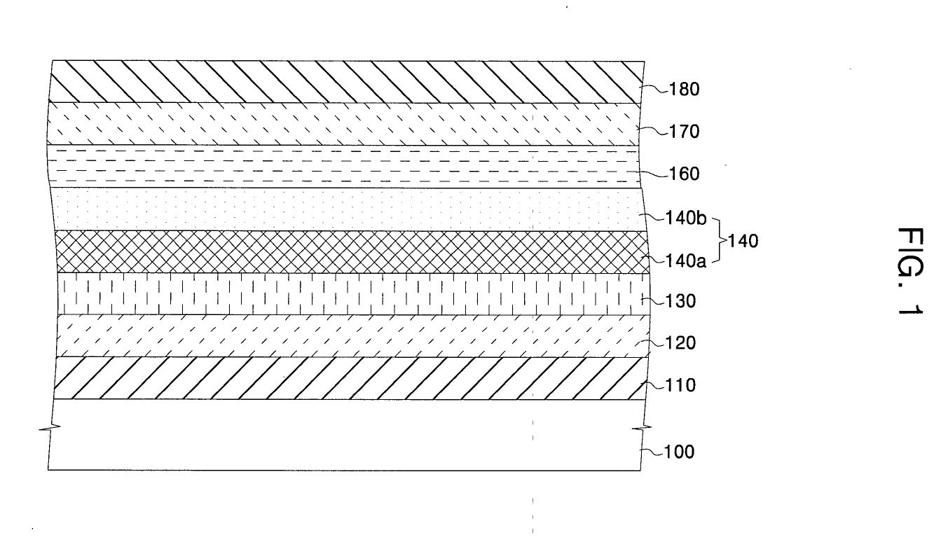

As shown in FIG. 1, a first electrode 110 may be formed on a substrate 100. The first electrode 110 may be a transparent electrode or a reflective electrode. If the first electrode 110 is a transparent electrode, it may be formed of Indium Tin Oxide (ITO) or Indium Zinc Oxide (IZO), and if the first electrode 110 is a reflective electrode, it may be formed a material such as Ag, Al, Ni, Pt, Pd, or an alloy thereof. The first electrode 110 may serve as an anode.

A hole injecting layer (HIL) 120 as a charge injecting layer and a hole transport layer (HTL) 130 as a charge transport layer may be sequentially formed on the first electrode 110. The HIL 120 or the HTL 130 may be omitted. The HIL 120 may serve to facilitate hole injection into an emission layer to be formed in a subsequent process, and may be formed of a polymer material such as PANI(polyaniline) or PEDOT(poly(3,4)-ethylenedioxythiophene), or of a small molecule material such as CuPc(copper phthalocyanine), TNATA, TCTA, TDAPB, or TDATA. In addition, the HTL 130 may serve to facilitate hole transport into the emission layer to be formed in a subsequent process, and may be formed of a polymer material such as PVK, or of a small molecule material such as α-NPB, TPD, s-TAD, or MTADATA.

A polymer emission layer 140a may be formed on the HTL 130. The polymer emission layer 140a may be an emission layer formed of π-conjugated polymer material, and may be formed by spin coating, ink-jet deposition, laser induced thermal imaging (LITI), or any other suitable technique. The polymer emission layer 140a may be formed to emit light in the blue or orange-red range. The polymer emission layer 104a may emit blue light having a wavelength of about 440 nm to about 500 nm, and may emit orange-red light having a wavelength of about 560 nm to about 620 nm. The polymer emission layer 140a may show an emission spectrum having a large width within each of the above-mentioned ranges in terms of the properties of the π-conjugated polymer material.

If the polymer emission layer 140a is adapted to emit light in the blue range, it may be formed of one polymer or a copolymer of at least two kinds of polymer such as poly phenylenevinylene (PPV)-based, polyfluorene-based, poly p-phenylene (PPP)-based, polyalkylthiophene-based, or polypyridine (Ppy)-based polymers. Alternatively, if the polymer emission layer 140a is formed to emit the light in the orange-red range, it may be formed of a copolymer of one polymer such as poly phenylenevinylene (PPV)-based, polyfluorene-based, poly p-phenylene (PPP)-based, polyalkylthiophene-based, or polypyridine (Ppy)-based polymers, and one polymer such as a PPV-based or polyalkylthiophene-based polymer.

Next, a small-molecule emission layer 140b may be formed on the polymer emission layer 140a. If the polymer emission layer 140a is adapted to emit light in the blue range, the small-molecule emission layer 140b may be adapted to emit light in the orange-red range. Alternatively, if the polymer emission layer 140a is adapted to emit light in the orange-red range, the small-molecule emission layer 140b may be adapted to emit light in the blue range. The orange-red light emitted from the small-molecule emission layer 140b may have a wavelength of about 560 nm to about 620 nm, and the blue light emitted from the small-molecule emission layer 140b may have a wavelength of about 440 nm to about 500 nm.

If the small-molecule emission layer 140b is adapted to emit light in the orange-red range, it may be adapted to emit phosphorescent light in the orange-red range employing a phosphorous material with excellent lifetime and efficiency characteristics. In this case, the small-molecule emission layer 140b emitting the phosphorescent light in the orange-red range may contain a host material such as arylamine-based, carbazole-based, or spiro-based materials. The host material may be a material such as CBP(4,4-N,N dicarbazole-biphenyl), CBP derivative, mCP(N,N-dicarbazolyl-3,5-benzene), or mCP derivative. The small-molecule emission layer 140b emitting the phosphorescent light in the orange-red range may contain a phospho-organic metal complex as a dopant, and the phospho-organic metal complex may have one central metal such as Ir, Pt, Tb, or Eu. Preferably, the phospho-organic metal complex may be a material such as PQIr, PQIr(acac), PQ₂Ir(acac), PIQIr(acac), or PtOEP.

Alternatively, if the small-molecule emission layer 140b is adapted to emit light in the blue range, the small-molecule emission layer 140b may be adapted to emit fluorescent light in the blue range employing a fluorescent material with excellent lifetime characteristics. In this case, the small-molecule emission layer 140b emitting the fluorescent light in the blue range may contain a material such as distyrylarylene (DSA), DSA derivative, distyrylbenzene (DSB), DSB derivative, DPVBi(4,4′-bis(2,2′-diphenyl vinyl)-1,1′-biphenyl), DPVBi derivative, spiro-DPVBi, or spiro-6P(spiro-sexyphenyl). In addition, in view of luminous efficiency the small-molecule emission layer 140b emitting the fluorescent light in the blue range may further contain a dopant such as styrylamine-based, pherylene-based, or DSBP (distyrylbiphenyl)-based materials.

The polymer emission layer 140a and the small-molecule emission layer 140b may form an emission layer (EML) 140. Alternatively, the polymer emission layer 140a may be formed on the small-molecule emission layer 140b.

Next, an electron transport layer (ETL) 160 as a charge transport layer and an electron injecting layer (EIL) 170 as a charge injecting layer may be sequentially formed on the small-molecule emission layer 140b. The ETL 160 or the EIL 170 may be omitted as desired. The ETL 160 may serve to facilitate the electron transport into the emission layer 140 and, for example, may be formed of a material such as TAZ, PBD, spiro-PBD, Alq3, BAlq, or SAlq. The EIL 170 may serve to facilitate electron injection into the emission layer 140 and, for example, may be formed of Alq3, LiF, Ga complex, or PBD.

Next, a second electrode 180 may be formed on the EIL 170. The second electrode 180 may be formed of a material such as Mg, Ca, Al, Ag, Ba, or an alloy thereof. It may be thin enough to allow light to be transmitted if the second electrode is a transparent electrode and thick if the second electrode is a reflective electrode.

The second electrode 180 may serve as a cathode. At least one of the first electrode 110 and the second electrode 180 may be a transparent electrode through which the light may pass.

Alternatively, the first electrode 110 may serve as a cathode and the second electrode 180 may serve as an anode.

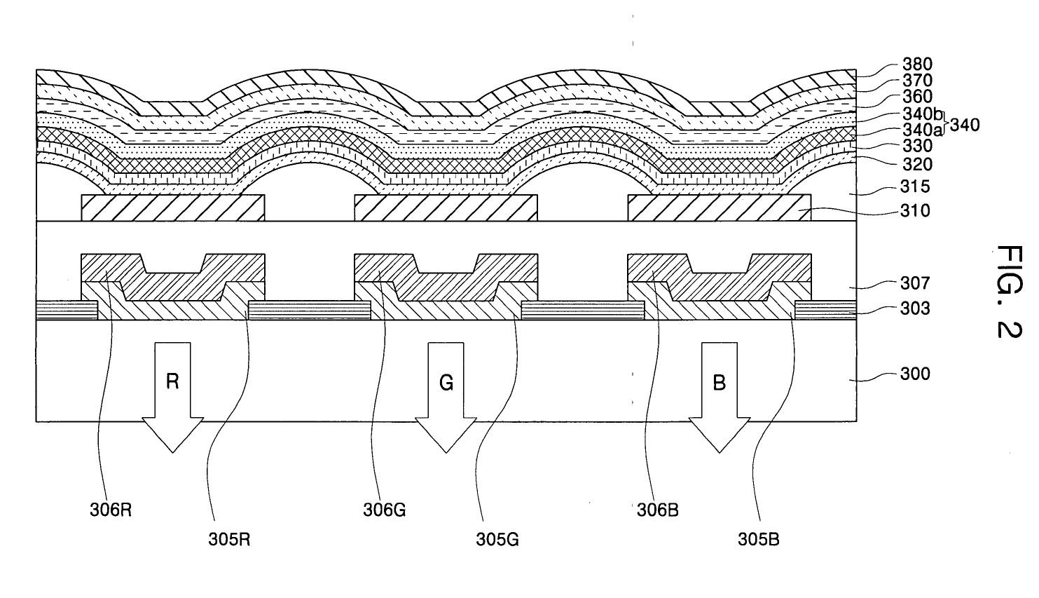

As shown in FIG. 2, an insulating substrate 300 may be provided. The insulating substrate 300 may be provided with a transparent substrate. Black matrixes 303 which may be spaced apart from one another may be formed on the insulating substrate 300. The black matrixes 303 may serve to absorb external light and scattered light. A red color filter layer 305R, a green color filter layer 305G, and a blue color filter layer 305B may be formed between the black matrixes 303, respectively.

Each of the color filter layers may include a pigment and a polymer binder, and the red color filter layer 305R, the green color filter layer 305G, and the blue color filter layer 305B may respectively selectively allow light in the red wavelength range, light in the green wavelength range, and light in the blue wavelength range to be transmitted. This selective transmission may be from among the light emitted from an emission layer formed in a subsequent process. The red color filter layer 305R, the green color filter layer 305G, and the blue color filter layer 305B may include pigments having different properties from one another.

A red color conversion layer 306R, a green color conversion layer 306G, and a blue color conversion layer 306B may be formed on the color filter layers 305R, 305G, and 305B, respectively. The color conversion layers may be omitted. The color conversion layer may include a fluorescent material and a polymer binder. The fluorescent material may be excited by light incident from the emission layer and may transition to a ground state to emit light having a wavelength longer than that of the incident light. Accordingly, the red color conversion layer 306R, the green color conversion layer 306G, and the blue color conversion layer 306B may include fluorescent materials having different properties from one another.

Next, an overcoating layer 307 may be formed on the substrate where the color conversion layers 306R, 306G, and 306B are already formed. The overcoating layer 307 may be a transparent layer. The overcoating layer 307 may serve not only to protect the color filter layers 305R, 305G, and 305B, and the color conversion layers 306R, 306G, and 306B from physical damages but also to alleviate steps produced in the formation of the color filter layers and the color conversion layers. First electrodes 310 may be formed on the overcoating layer 307 corresponding to the color filter layers 305R, 305G, and 305B, respectively. The first electrodes 310 may be formed of transparent electrodes.

A pixel defining layer 315 may be formed to have an opening exposing portions of surfaces of the first electrodes 310 on the substrate 100 where the first electrodes 310 are already formed. The pixel defining layer 315, for example, may be formed of an acryl-based organic layer. Next, a polymer emission layer 340a and a small-molecule emission layer 340b may be sequentially formed on the entire surface of the substrate including the exposed first electrodes 310. The polymer emission layer 340a and the small-molecule emission layer 340b may form an emission layer 340. A hole injecting layer 320 and/or a hole transport layer 330 may be further formed on the exposed first electrode 310 prior to formation of the polymer emission layer 340a. In addition, an electron transport layer 360 and/or an electron injecting layer 370 may be formed on the small-molecule emission layer 340b after the small-molecule emission layer 340b is formed. Next, a second electrode 380 may be formed on the electron injecting layer 370.

The detailed description about the first electrode 310, the hole injecting layer 320, the hole transport layer 330, the polymer emission layer 340a, the small-molecule emission layer 340b, the electron transport layer 360, and the electron injecting layer 370 refers to the first embodiment.

Alternatively, the first electrode 310 may be formed as a cathode and the second electrode 380 may be formed as an anode. In addition, positions of the polymer emission layer 340a and the small-molecule emission layer 340b may be swapped.

If the organic EL display is driven, the emission layer 340 emits white light. The white light emitted from the emission layer 340 may exit through the first electrode 310. The first electrode 310 may be a transparent electrode and the substrate 300 may be a transparent substrate. In this case, the color filter layers 305R, 305G, and 305B and/or the color conversion layers 306R, 306G, and 306B may be positioned in the light transmission path from the emission layer 340 to the exterior.

Accordingly, if the organic EL display is driven, white light emitted from the emission layer 340 may transmit through the red color filter layer 305R, the green color filter layer 305G, and the blue color filter layer 305B and out to the exterior. Alternatively, the white light may transmit through the stacked structure of the red color conversion layer 306R and the red color filter layer 305R, the stacked structure of the green color conversion layer 306G and the green color filter layer 305G and the stacked structure of the blue color conversion layer 306B and the blue color filter layer 305B and out to the exterior. As a result, the organic EL display may realize full color from R, G, and B colors. Further, if the stacked structure of the color conversion layer and the color filter layer are formed, color purity may be improved.

The present invention has been described with reference to a bottom emitting organic display, however, the present invention may also be applied to a top emitting or double side emitting EL display within the scope of the present invention.

Hereinafter, examples of the present invention will be given to help better understand the present invention. However, these examples are exemplary only and not limiting.

<Fabrication Example of Polymer-Small-Molecule Hybrid White-Light-Emitting Organic EL Device>

ITO was employed on a substrate to form a first electrode having an area of 2 mm×2 mm, which was subjected to ultrasonic cleaning and UV-O₃ treatment. On the first electrode subjected to the UV-O₃ treatment, PEDOT:PSS (available from Baytron P TP CH8000, Bayer AG) was spin-coated to a thickness of about 800 Å to form a hole injecting layer. The substrate was baked at a high temperature not less than 100° C. to remove remaining moisture in the hole injecting layer.

Poly(9,9′-dioctylfluorene-co-bis-N,N′-(4-ethoxycarbonylphenyl)-bis-N,N′-phenyl-benzidine:BFE (available from Dow chemical) was dissolved in a toluene solution to have 1.0 wt. %, and then spin-coated on the hole injecting layer to have a thickness of about 200 Å, thereby forming a hole transport layer. The hole transport layer was thermally treated at a temperature of 250° C. Next, LUMATION Blue J Light Emitting Polymer (available from Dow Chemical) was dissolved in a toluene solution to have 1.0 wt. %, and then spin-coated on the hole transport layer to have a thickness of about 200 Å, thereby forming a polymer emission layer emitting light in the blue range.

The substrate having the polymer emission layer was thermally treated at a temperature of 80° C. for 30 minutes, and a small-molecule emission layer, emitting light in the orange-red range and having CBP (available from UDC) and Bt2Ir(acac)[bis(2-phenyl benzothiozolato-N,C2′)iridium(acetylacetonate)] of 3 wt. %, was formed to a thickness of about 200 Å. On the small-molecule emission layer, BAlq was vacuum deposited to a thickness of about 30 Å, Alq3 was vacuum deposited to a thickness of about 200 Å, and LiF was vacuum deposited to a thickness of about 20 Å, so that a hole blocking layer, an electron transport layer, and an electron injecting layer were sequentially formed.

Al was vacuum deposited on the electron injecting layer to have a thickness of about 3000 Å, thereby forming a second electrode.

### FIRST COMPARATIVE EXAMPLE FABRICATION OF SMALL-MOLECULE WHITE-LIGHT-EMITTING ORGANIC EL DEVICE

ITO was employed on a substrate to form a first electrode having an area of 2 mm×2 mm, which was subjected to ultrasonic cleaning and UV-O₃ treatment. On the first electrode subjected to the UV-O₃ treatment, TDATA was vacuum deposited to a thickness of about 600 Å to form a hole injecting layer. α-NPB was then vacuum deposited to a thickness of 300 Å on the hole injecting layer to form a hole transport layer.

A first small-molecule emission layer having DPVBi and 4,4′-bis[2,2′-di(4-dialkylaminophenyl)vinyl]-1,1′-biphenyl of 1.5 wt. % was formed on the hole transport layer to have a thickness of about 75 Å. A second small-molecule emission layer having DPVBi and IDEMITSU-P 1 (available from IDEMITSU Co.) of 3 wt. % was formed on the first small-molecule emission layer to have a thickness of about 300 Å. On the second small-molecule emission layer, Alq3 was vacuum deposited to a thickness of about 300 Å and LiF was vacuum deposited to a thickness of about 20 Å, so that an electron transport layer and an electron injecting layer were sequentially formed. Al was vacuum deposited on the electron injecting layer to have a thickness of about 3000 Å, thereby forming a second electrode.

### SECOND COMPARATIVE EXAMPLE FABRICATION OF POLYMER WHITE-LIGHT-EMITTING ORGANIC EL DEVICE

ITO was employed on a substrate to form a first electrode having an area of 2 mm×2 mm, which was subjected to ultrasonic cleaning and UV-O₃ treatment. On the first electrode subjected to the UV-O₃ treatment, PEDOT:PSS (available from Baytron P TP CH8000, Bayer AG) was spin-coated to a thickness of about 800 Å to form a hole injecting layer. The substrate was baked at a high temperature not less than 100° C. to remove remaining moisture in the hole injecting layer.

Poly(9,9′-dioctylfluorene-co-bis-N,N′-(4-ethoxycarbonylphenyl)-bis-N,N′-phenyl-benzidine:BFE (available from Dow chemical) was dissolved in a toluene solution to have 1.0 wt. %, and then spin-coated on the hole injecting layer to have a thickness of about 200 Å, thereby forming a hole transport layer. The hole transport layer was thermally treated at a temperature of about 250° C. Next, CW-004 (available from Covion Organic Semiconductor GmbH) was dissolved in a toluene solution to have 1.0 wt. %, and then spin-coated on the hole transport layer to have a thickness of about 400 Å, thereby forming a polymer emission layer emitting white light.

Next, LiF was vacuum deposited to a thickness of about 20 Å to form an electron injecting layer, and Al was vacuum deposited to a thickness of about 3000 Å to form a second electrode.

Driving voltages, luminance efficiencies, and chromaticity coordinates of the white-light-emitting organic EL devices fabricated by the fabrication example, and the first and second comparative examples were shown in Table 1 below.

TABLE 1

| | | Luminous | Chromaticity |
|---|---|---|---|
| | Luminance | efficiency | coordinate |
| | (cd/m², @6 V) | (cd/A, @6 V) | (X, Y) |
| Fabrication example | 500 | 12 | (0.33, 0.36) |
| First comparative | 150 | 9 | (0.29, 0.35) |
| example | | | |
| Second comparative | 120 | 4.4 | (0.30, 0.36) |
| example | | | |

As shown in Table 1, the organic EL device according to the fabrication example shows chromaticity coordinates capable of emitting proper white light. Furthermore, it can be seen that the luminance and luminous efficiency of the organic EL device according to the fabrication example can be enhanced over the organic EL devices according to the comparative examples. In particular, it can be seen that the luminous efficiency of the organic EL device according to the fabrication example may be significantly enhanced over the organic EL device according to the second comparative example.

In addition, electroluminescence spectra were measured with respect to the organic EL devices fabricated by the fabrication example and the first comparative example. Thus the organic EL device fabricated by the first comparative example showed a weak luminescence intensity in a wavelength range of 520 nm to 580 mm. However, the organic EL device fabricated by the fabrication example showed a luminescence peak having a large width in a wavelength range of 460 nm to 620 nm (in the visible range). Thus good white light generation was seen.

In accordance with the present invention as mentioned above, an emission layer in which a polymer emission layer and a small-molecule emission layer are combined is employed. Thus a white-light-emitting organic EL device and an organic EL display having the same may be obtained. In such a device or display the white light may be better generated than in a small-molecule device and the luminous efficiency may be improved over a polymer device.

Although the present invention has been described with reference to certain exemplary embodiments thereof, a variety of changes may be made to the described embodiments without departing from the scope of the present invention.

1. A white-light-emitting organic electroluminescent (EL) device, comprising:
a first electrode;
a second electrode; and
an emission layer interposed between the first electrode and the second electrode,
wherein the emission layer has a stacked structure including a polymer emission layer and a small-molecule emission layer.

2. The organic EL device of claim 1, wherein the polymer emission layer is adapted to emit light in a blue range, and the small-molecule emission layer is adapted to emit light in an orange-red range.

3. The organic EL device of claim 2, wherein the polymer emission layer comprises one polymer or a copolymer of at least two kinds of materials selected from a group of poly phenylenevinylene (PPV)-based, polyfluorene-based, poly p-phenylene (PPP)-based, polyalkylthiophene-based, and polypyridine (Ppy)-based polymers.

4. The organic EL device of claim 2, wherein the small-molecule emission layer is adapted to emit phosphorescent light in an orange-red range.

5. The organic EL device of claim 4, wherein the small-molecule emission layer comprises a host material selected from a group of CBP(4,4-N,N dicarbazole-biphenyl), a CBP derivative, mCP(N,N-dicarbazolyl-3,5-benzene), and an mCP derivative.

6. The organic EL device of claim 4, wherein the small-molecule emission layer comprises a dopant material selected from a group of PQIr, PQIr(acac), PQ₂Ir(acac), PIQIr(acac), and PtOEP.

7. The organic EL device of claim 1, wherein the polymer emission layer is adapted to emit light in an orange-red range, and the small-molecule emission layer is adapted to emit light in a blue range.

8. The organic EL device of claim 7, wherein the polymer emission layer comprises a copolymer of one polymer selected from a group of poly phenylenevinylene (PPV)-based, polyfluorene-based, poly p-phenylene (PPP)-based, polyalkylthiophene-based and polypyridine (PPy)-based polymers, and one polymer selected from a group of a PPV-based and a polyalkylthiophene-based polymer.

9. The organic EL device of claim 7, wherein the small-molecule emission layer is adapted to emit fluorescent light in a blue range.

10. The organic EL device of claim 9, wherein the small-molecule emission layer comprises one material selected from a group of distyrylarylene (DSA), a DSA derivative, distyrylbenzene (DSB), a DSB derivative, DPVBi(4,4′-bis(2,2′-diphenyl vinyl)-1,1′-biphenyl), a DPVBi derivative, spiro-DPVBi, and spiro-6P(spiro-sexyphenyl).

11. The organic EL device of claim 10, wherein the small-molecule emission layer further comprises a dopant material selected from a group of styrylamine-based, pherylene-based, and DSBP(distyrylbiphenyl)-based materials.

12. An organic electroluminescent (EL) display, comprising:
a first electrode and a second electrode, at least one of the first electrode and the second electrode comprising a transparent electrode;
an emission layer interposed between the first electrode and the second electrode; and
a color filter layer positioned at a path where light is taken out from the emission layer to the exterior,
wherein the emission layer has a stacked structure comprising a polymer emission layer and a small-molecule emission layer, and
wherein the emission layer is adapted to emit white light when driven.

13. The organic EL display of claim 12, wherein the polymer emission layer is adapted to emit light in a blue range, and the small-molecule emission layer is adapted to emit light in an orange-red range.

14. The organic EL display of claim 13, wherein the polymer emission layer comprises one polymer or a copolymer of at least two kinds of materials selected from a group of poly phenylenevinylene (PPV)-based, polyfluorene-based, poly p-phenylene (PPP)-based, polyalkylthiophene-based, and polypyridine (Ppy)-based polymers.

15. The organic EL display of claim 13, wherein the small-molecule emission layer is adapted to emit phosphorescent light in an orange-red range.

16. The organic EL display of claim 15, wherein the small-molecule emission layer comprises a host material selected from a group of CBP(4,4-N,N dicarbazole-biphenyl), a CBP derivative, mCP(N,N-dicarbazolyl-3,5-benzene) and an mCP derivative, and comprises a dopant material selected from a group of PQIr, PQIr(acac), PQ₂Ir(acac), PIQIr(acac) and PtOEP.

17. The organic EL display of claim 12, wherein the polymer emission layer is adapted to emit light in an orange-red range, and the small-molecule emission layer is adapted to emit light in a blue range.

18. The organic EL display of claim 17, wherein the polymer emission layer comprises a copolymer of one polymer selected from a group of poly phenylenevinylene (PPV)-based, polyfluorene-based, poly p-phenylene (PPP)-based, polyalkylthiophene-based and polypyridine (PPy)-based polymers, and one polymer selected from a group of a PPV-based and a polyalkylthiophene-based polymer.

19. The organic EL display of claim 17, wherein the small-molecule emission layer is adapted to emit fluorescent light in a blue range.

20. The organic EL display of claim 19, wherein the small-molecule emission layer comprises a material selected from a group of distyrylarylene (DSA), a DSA derivative, distyrylbenzene (DSB), a DSB derivative, DPVBi(4,4′-bis(2,2′-diphenyl vinyl)-1,1′-biphenyl), a DPVBi derivative, spiro-DPVBi and spiro-6P(spiro-sexyphenyl), and comprises a dopant material selected from a group of styrylamine-based, pherylene-based, and DSBP(distyrylbiphenyl)-based materials.
